(19) United States
(12) Patent Application Publication
(10) Pub. No.: US 2007/0228852 A1
(43) Pub. Date: Oct. 4, 2007

(54) Magnetically-levitated telescopic land indicator

(76) Inventor: Tsai-Jung Chiang, Taipei Hsien (TW)

Correspondence Address: CHIANG TSAI-JUNG, 235 Chung-Ho, Box 8-24, Taipei, omitted

(21) Appl. No.: 11/724,780

(22) Filed: Mar. 12, 2007

(30) Foreign Application Priority Data
Mar. 29, 2006 (TW) 095205204

(51) Int. Cl. H02K 7/09; G02B 7/182

(52) U.S. Cl. 310/90.5; 359/871

(57) ABSTRACT

A magnetically-levitated telescopic land indicator comprises a sleeve having an end surface; the end surface having an opening; a seat combined to the sleeve so as to form an inner space for receiving other elements; a magnetic levitated telescopic cylinder installed to the downward concave portion of the seat; the magnetically-levitated telescopic cylinder being installed in an inner space between the seat and the sleeve; at least two permanent magnets being installed within the magnetically-levitated telescopic cylinder; the permanent magnets having same magnetic polarities so that the permanent magnets being repulsive to one another; and an actuator being made of strengthened transparent material; the actuator having a dome shape protrusion at an upper end; an edge portion being arranged around an edge of the protrusion, and the protrusion protruding from the opening in the end surface of the sleeve.

### FIELD OF THE INVENTION

The present invention relates to land indicators, and particularly to a magnetically-levitated telescopic land indicator, wherein permanent magnets are used to telescopically control a magnetically-levitated telescopic cylinder so as to avoid the elastic fatigue of the spring which is used in the prior art. Thus, the lifetime of the land indicator is prolonged. Furthermore, the permanent magnets can absorb a reflecting unit so as to prevent the reflecting unit from falling out.

### BACKGROUND OF THE INVENTION

The land indicator in load has the effect of traffic safety. In daytime, if the car is shifted from the load, the car will compress the land indicator so as to alert the driver. At night, the land indicator can reflect light incident thereupon so as to project to the driver's eyes to alert the drivers.

Initially, the land indicator is fixed to the ground and has a glass surface for reflecting light so as to reduce the friction force between the tire surface and the load surface. However to reduce the danger for undesired tire shifting, the land indicator is made as a telescopic structure. When the car presses the land indicator, the elastic element therein will make the land indicator descends and then the elastic element therein has the effect of restoring the land indicator.

However above mentioned structure can avoid the danger of tire shift, but as the land indicator is used for a long time, the elastic element will be fatigue or oxidized to as to break. Thus, the land indicator can not work normally. As a result, the land indicator can not restore to the original state.

### SUMMARY OF THE INVENTION

Accordingly, the primary object of the present invention is to provide a magnetically-levitated telescopic land indicator, wherein permanent magnets are used to telescopically control a magnetically-levitated telescopic cylinder so as to avoid the elastic fatigue of the spring which is used in the prior art. Thus, the lifetime of the land indicator is prolonged. Furthermore, the permanent magnets can absorb a reflecting unit so as to prevent the reflecting unit from falling out.

To achieve above objects, the present invention provides a magnetically-levitated telescopic land indicator which comprises a sleeve having an end surface; the end surface having an opening; a seat combined to the sleeve so as to form an inner space for receiving other elements; a magnetically levitated telescopic cylinder installed to the downward concave portion of the seat; the magnetically-levitated telescopic cylinder being installed in an inner space between the seat and the sleeve; at least two permanent magnets being installed within the magnetically-levitated telescopic cylinder; the permanent magnets having same magnetic polarities so that the permanent magnets being repulsive to one another; and an actuator being made of strengthened transparent material; the actuator having a dome shape protrusion at an upper end; an edge portion being arranged around an edge of the protrusion, the protrusion protruding from the opening in the end surface of the sleeve. When a car passing through the magnetically-levitated telescopic land indicator of the present invention, the protrusion will be compressed to move downwards so that the magnetically-levitated telescopic cylinder 2 is compressed. The permanent magnets will also compress so as to store energy. When the car passes through the magnetically-levitated telescopic land indicator, the permanent magnets will provide magnetic resilient force to restore the actuator.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is an explosive schematic view of the present invention.]

FIG. 3 is an exploded cross sectional view of the present invention.

FIG. 4 is a schematic cross sectional view of the present invention which has been assembled.

FIG. 5 is a schematic view showing the operation of the present invention as an external pressure is applied to the land indicator of the present invention.

FIG. 6 shows another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

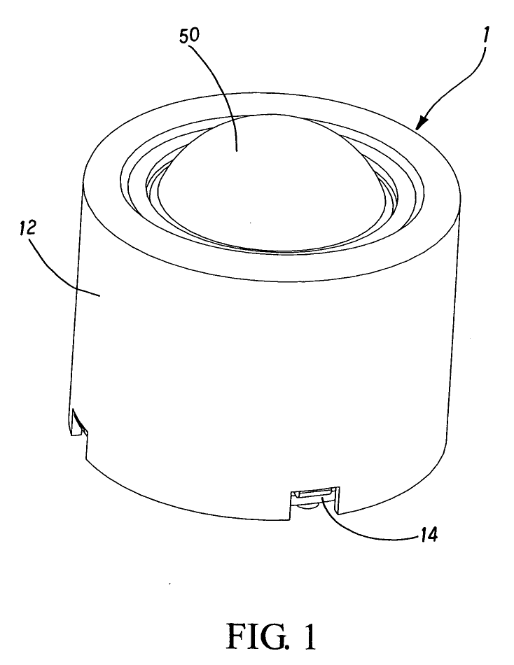

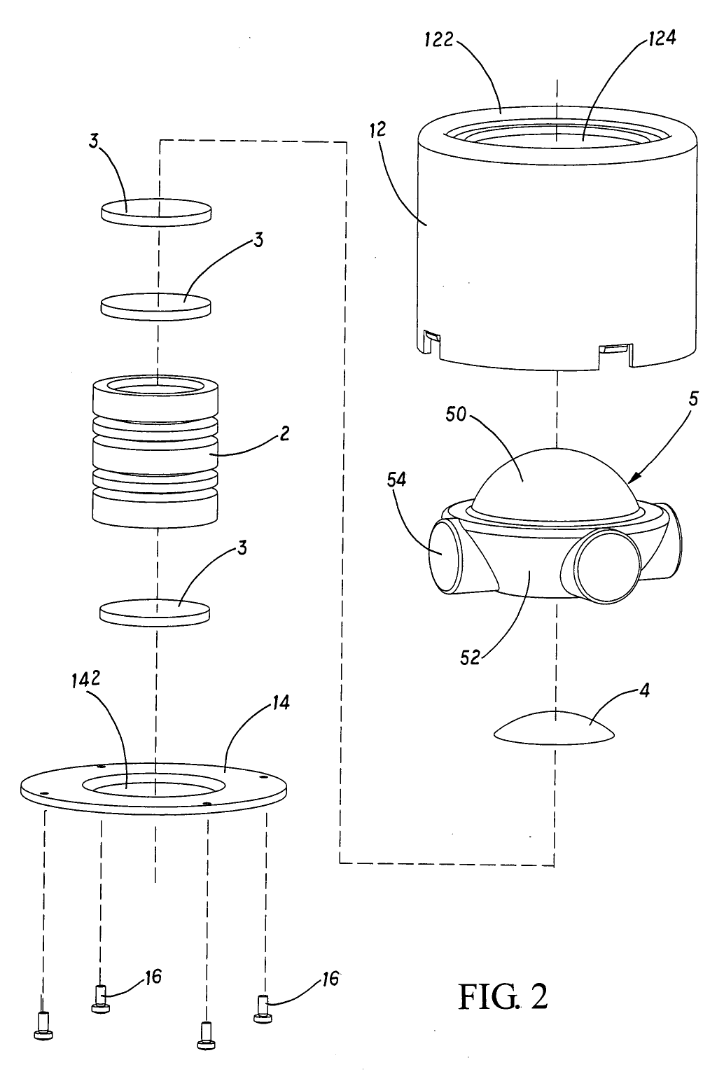

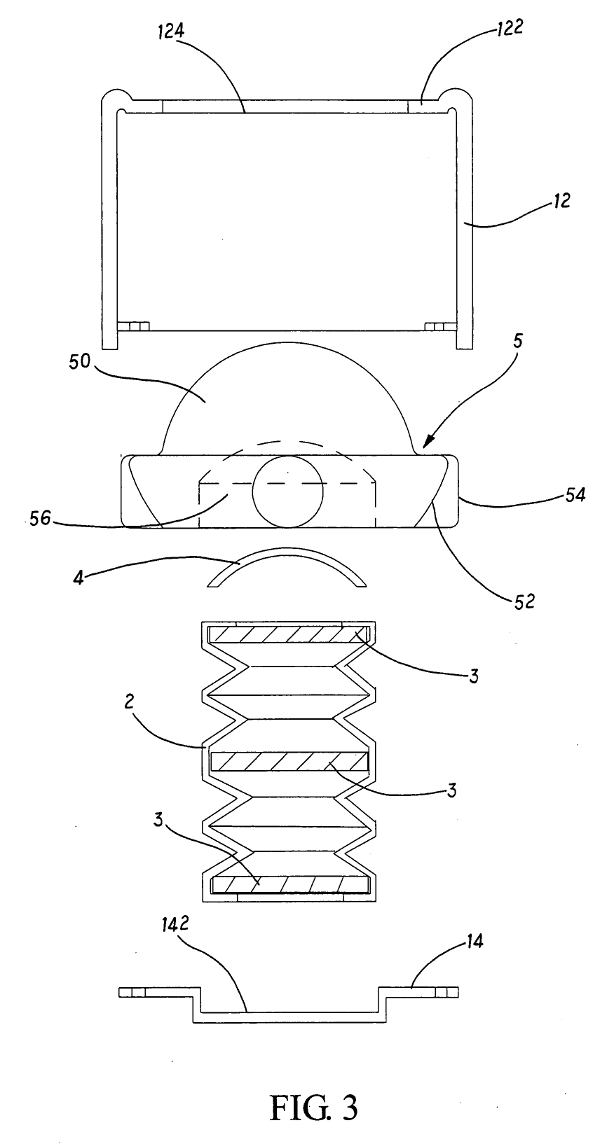

Referring to FIGS. 1 to 3 the structure of the present invention is illustrated. The magnetically-levitated telescopic land indicator 1 of the present invention has the following elements.

A sleeve 12 has an end surface 122. The end surface 122 has an opening 124.

A seat 14 has a downward concave portion 142. The seat 14 is combined to the sleeve 12 so as to form an inner space for receiving other elements. The seat 14 is combined to the sleeve 12 by studs 16. However other ways for combining the sleeve 12 to the seat 14 are permissible in the present invention. For example the sleeve 12 is buckled to the seat 14 or the sleeve 12 is combined with the seat 14 by tenons.

A magnetically levitated telescopic cylinder 2 is installed to the downward concave portion 142 of the seat 14. The magnetically-levitated telescopic cylinder 2 has a resisting effect and stand in the inner space between the seat 14 and the sleeve 12. The magnetically-levitating telescopic cylinder 2 has a snake like structure which is formed by elastic material, such as plastics or rubbers. At least two permanent magnets 3 are installed within the magnetically-levitated telescopic cylinder 2. The permanent magnets 3 have same magnetic polarities, such as N magnetic poles or S magnetic poles, so that the permanent magnets 3 are repulsive to one another. In the drawing, the permanent magnets 3 are installed at an upper, middle and lower sections of the magnetically-levitated telescopic cylinder 2, however this is not used to confine the scope of the present invention. The number and arrangement of the present invention are confined to the above mentioned structure. The permanent magnets 3 has the effect of providing that the volume of the magnetically-levitated telescopic cylinder 2 has a finite value as it is compressed. When the structure of the present invention is compressed, the magnetically-levitated telescopic cylinder 2 can be resilient.

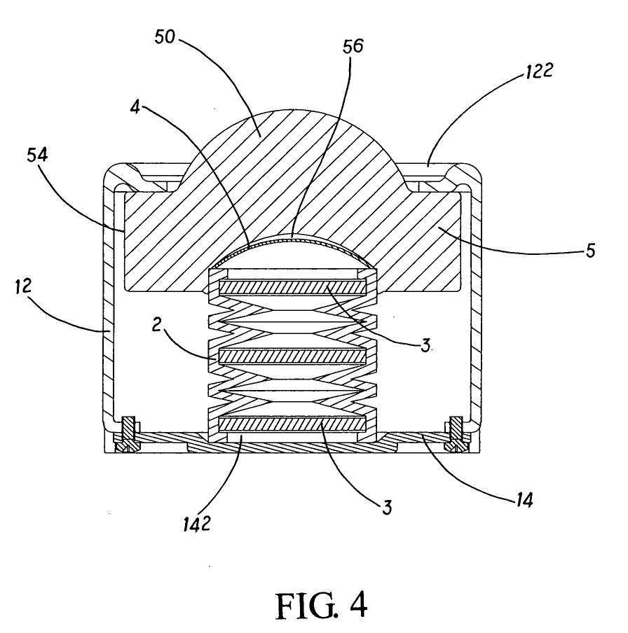

Referring to FIGS. 1 and 4, the actuator 5 is made of strengthened glass or other strengthened transparent material (such as strengthen plastics). The actuator 5 has a dome shape protrusion 50 at an upper end. An edge portion 52 is arranged around an edge of the protrusion 50. A plurality of projectors 54 are outwards protruded from the edge portion 52. When the sleeve 12 is compressed, the projectors 54 generate gaps so that sands or dirt will fall into the inner space of the sleeve 12 without affecting the function of the present invention. In assembly, the protrusion 50 protrudes from the opening 124 in the end surface 122 of the sleeve 12. The edge portion 52 of the actuator 5 resists against an inner side of the edge portion 52. Referring to FIG. 1, the perspective view of the present invention is illustrated. In use, the structure of the present invention is embedded under the ground, only the protrusion 50 of the actuator 5 protrudes from the ground. In this embodiment, the protrusion 50 has a shape like a part of a ball, however other shape is permissible, such as a polygonal three dimensional structure.

The reflecting unit 4 is installed at a top of the magnetically-levitated telescopic cylinder 2 and is contained in a top of the magnetically-levitated telescopic cylinder 2 and is installed between the actuator 5 and the magnetically-levitated telescopic cylinder 2. The reflecting unit 4 is a convex cambered surface for reflecting light incident thereupon. The reflecting unit 4 is made of metal material and is plated with Chromium so as to prevent the reflecting unit 4 from breaking as the actuator 5 breaks due to the pressure from car passing through the structure of the present invention. Furthermore, when the structure of the present invention is broken, the permanent magnet 3 will absorb the reflecting unit 4 or make the reflecting unit 4 is retained within the sleeve 12 without dropping out to induce some traffic accidents.

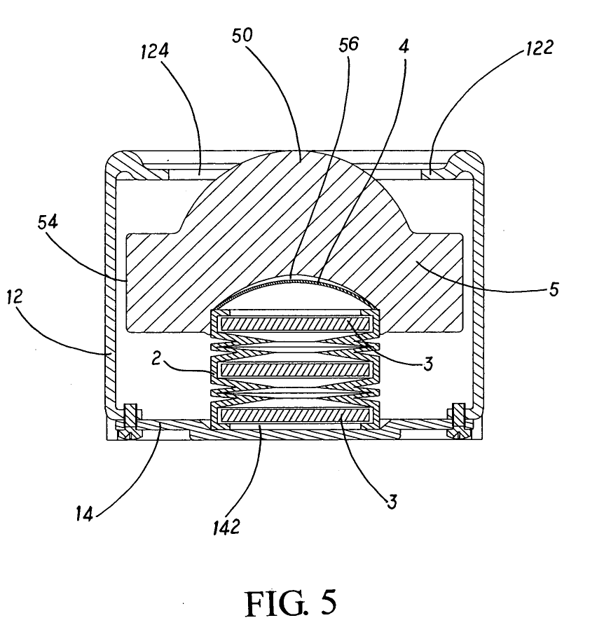

Referring to FIG. 5, it is illustrated that when a car passing through the magnetically-levitated telescopic land indicator of the present invention, the protrusion 50 will be compressed to move downwards so that the magnetically-levitated telescopic cylinder 2 is compressed. The permanent magnets 3 will also compress so as to store energy. When the car passes through the magnetically-levitated telescopic land indicator, the permanent magnets 3 will provide magnetic resilient force to restore the actuator 5 to a state illustrated in FIG. 4.

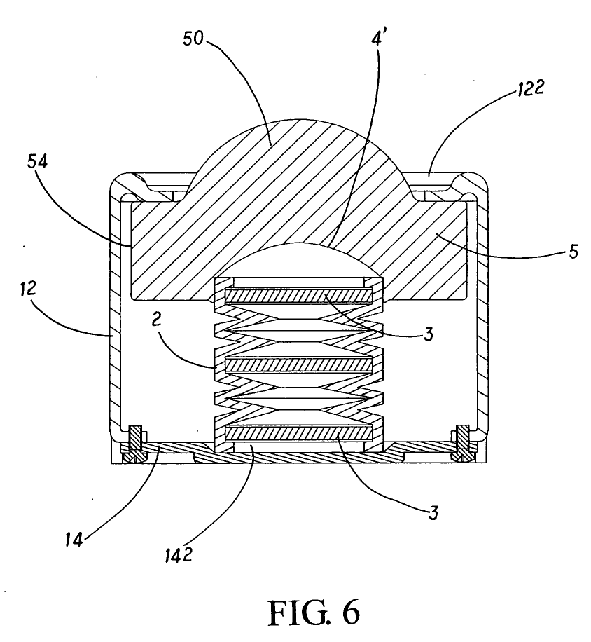

Referring, to FIG. 6, another embodiment of the present invention is illustrated. In this embodiment, those identical to the above embodiment will not be further described herein. Only those different from above embodiment are described. In this the present invention, no reflecting unit is used, but a reflecting layer 4′ is coated upon a lower surface of the actuator 5 for reflecting incident light.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A magnetically-levitated telescopic land indicator, comprising:
a sleeve having an end surface; the end surface having an opening;
a seat combined to the sleeve so as to form an inner space for receiving other elements;
a magnetically levitated telescopic cylinder installed to the downward concave portion of the seat; the magnetically-levitated telescopic cylinder being installed in an inner space between the seat and the sleeve; at least two permanent magnets being installed within the magnetically-levitated telescopic cylinder; the permanent magnets having same magnetic polarities so that the permanent magnets being repulsive to one another; and
an actuator being made of strengthened transparent material; the actuator having a dome shape protrusion at an upper end; an edge portion being arranged around an edge of the protrusion, and the protrusion protruding from the opening in the end surface of the sleeve.

2. The magnetically-levitated telescopic land indicator as claimed in claim 1, wherein the edge portion of the actuator resists against an inner side of the edge portion.

3. The magnetically-levitated telescopic land indicator as claimed in claim 1, wherein the seat is combined to the sleeve by studs or by buckles or by tenons.

4. The magnetically-levitated telescopic land indicator as claimed in claim 1, wherein when the actuator breaks, the permanent magnet will absorb the reflecting unit or make the reflecting unit is retained within the sleeve without dropping out.

5. The magnetically-levitated telescopic land indicator as claimed in claim 1, wherein a reflecting unit is installed at a top of the magnetically-levitated telescopic cylinder, is contained in a top of the magnetically-levitated telescopic cylinder and is installed between the actuator and the magnetically-levitated telescopic cylinder.

6. The magnetically-levitated telescopic land indicator as claimed in claim 5, wherein the reflecting unit is a convex cambered surface for reflecting light incident thereupon.

7. The magnetically-levitated telescopic land indicator as claimed in claim 6, wherein the reflecting unit 4 is made of metal material and is plated with Chromium so as to prevent the reflecting unit from breaking as the actuator breaks.

8. The magnetically-levitated telescopic land indicator as claimed in claim 1, wherein the seat has a downward concave portion for locating the magnetically-levitated telescopic cylinder.

9. The magnetically-levitated telescopic land indicator as claimed in claim 1, wherein a plurality of projectors are protruded from the edge portion, when the sleeve is compressed.

10. The magnetically-levitated telescopic land indicator as claimed in claim 1, wherein a reflecting layer is coated upon a lower surface of the actuator for reflecting incident light.
